(19) United States
(12) Patent Application Publication
(10) Pub. No.: US 2019/0278638 A1
(43) Pub. Date: Sep. 12, 2019

(54) IMAGE DATA MANAGEMENT APPARATUS AND METHOD THEREFOR

(71) Applicant: Vault Micro, Inc., Seoul (KR)

(72) Inventors: Seong Il KIM, Seoul (KR); Yong hoon KIM, Osan-si (KR)

(21) Appl. No.: 16/338,146

(22) PCT Filed: Nov. 16, 2016
(86) PCT No.: PCT/KR2016/013226

§ 371 Date: Mar. 29, 2019

(30) Foreign Application Priority Data
Oct. 4, 2016 (KR) 10-2016-0127639

(51) Int. Cl. G06F 9/54; G06F 16/51; G06F 3/06

(52) U.S. Cl. CPC G06F 9/544; G06F 16/51; G06F 3/0604; G06F 2209/543; G06F 3/0659; G06F 3/0673; G06F 3/0647

(57) ABSTRACT

Provided is an image data management apparatus, by which the image data transferred to a mobile device from an image capturing device connected to the mobile device is managed. The apparatus may include a first controller located in a native layer for communicating with a java layer, a second controller located in a java layer for communicating with the native layer, and a shared memory in which the image data transferred from the image capturing device is stored. The first controller may store the image data transferred from the image capturing device in the shared memory when state information of the shared memory is at a first state, and change the state information of the shared memory to a second state when the image data is completely stored in the shared memory. The second controller may read the image data stored in the shared memory when the state information of the shared memory is at the second state, and change the state information of the shared memory to the first state when the image data stored in the shared memory is completely read.

### BACKGROUND OF THE INVENTION

### 1. Field of the Invention

The present invention relates to an image data management apparatus and method therefor, and more particularly, to an apparatus and a method of managing image data by which image data captured in an image capturing device connected to a mobile device may be transferred from a native layer to a java layer in the mobile device at high speed.

### 2. Description of the Related Art

A java language is continuously used in a mobile environment and is widely used in Connected Limited Device Configuration (CLDC) and Mobile Information Device Profile (MIDP), which are represented by java 2 Platform Micro Edition (J2ME), and Wireless Internet Platform for Interoperability (WIPI), which is Korean wireless internet standard platform.

Applications developed by a java language are generally operated on a virtual machine such as Java Virtual Machine/Kilobyte Virtual Machine (JVM/KVM) and thus, are stable in a mobile environment such as a smart phone. Also, a java language may be used easier than a C/C++ language and an assembly language and thus, is preferred by many developers. Accordingly, a java language is widely used in a mobile environment. In currently released smart phones, applications used by java language are used and thus, a use of a java language is gradually expanded in a mobile environment.

In android system, a java layer and a native layer are areas where programs created by using each different programming language are respectively run, and both layers may not be directly communicated with each other. Accordingly, a Java Native Interface (JNI) framework is provided in an android system for both programs run in a java layer and a native layer to interwork with each other.

A basic method of transferring data in the JNI is copying memories. Memory areas located in the java layer may not be accessed from the native layer and memory areas located in the native layer may not be accessed from the java layer. Thus, when data such as image data is to transfer to applications, image data received in the memory areas of the native layer is stored and then, is copied to the memory areas of the java layer. That is, in the conventional art, in order to transfer image data, which is transferred to a mobile device from an image capturing device connected to the mobile device, to applications, the image data received in the memory areas of the native layer is written and read. Then, the read data is stored again in the memory areas of the java layer and then, is read, thereby transferring the image data to the applications.

However, when the data is transferred from the native layer to the java layer by using the method above, a transfer rate is very slow and thus, images captured by the image capturing device such as a video camera may not be actually used in applications. Even if the images are played, a disconnection may occur. That is, a USB Host Application Programming Interface (API) set is provided from a java for controlling devices connected by a USB. However, when large data such as a USB Video Class (UVS) camera device is generated, 3 frames per second may not be transferred at SD resolution (640×480, MJPEG (Motion JPEG) compression) due to a data loss and delay. Such a problem occurs due to a limit of a maximum buffer size and a transfer delay occurring between the java layer and the native layer. Since the image data of above 24 frames per second makes users watch images naturally, a camera device with a transfer rate of 3 frames per second may not be actually used.

### SUMMARY OF THE INVENTION

The present invention provides to an image data management apparatus and method therefor in which image data captured in an external photographing device may be transferred from a native layer to a java layer in a mobile device at high speed.

According to an aspect of the present invention, there is provided an image data management apparatus for managing image data transferred to a mobile device from an image capturing device connected to the mobile device, the apparatus including: a first controller located in a native layer for communicating with a java layer; a second controller located in a java layer for communicating with the native layer; and a shared memory in which the image data transferred from the image capturing device is stored. The first controller may store the image data transferred from the image capturing device in the shared memory when state information of the shared memory is at a first state, and change the state information of the shared memory to a second state when the image data is completely stored in the shared memory. The second controller may read the image data stored in the shared memory when the state information of the shared memory is at the second state, and change the state information of the shared memory to the first state when the image data stored in the shared memory is completely read.

When it is recognized that the image capturing device is connected to the mobile device or when the image data is received from the image capturing device connected to the mobile device, the first controller may transfer a generation request signal to the second controller for requesting generation of the shared memory and when the second controller receives the generation request signal, the second controller may generate the shared memory, designate the state information of the shared memory as the first state, and transfer the information of the shared memory to the first controller.

When a plurality of image capturing devices is connected to the mobile device, the first controller may transfer the generation request signals to the second controller for each of the connected image capturing devices and the second controller may generate the shared memories for each of the plurality of image capturing devices by using the received generation request signals.

The generation request signal may include information about a frame size of the image data and the second controller may generate the shared memory having a size larger than the frame size by using the information about a frame size of the image data and transfer information of the shared memory having address information and the state information of the generated shared memory.

The first controller may transfer a completion signal when the image capturing device connected to the mobile device is separated from the mobile device or the image data is not received from the image capturing device, and the second controller may release an area set as the shared memory when the completion signal is received.

The first controller may store the image data in the shared memory in a frame unit and store at least one of timestamp information, size information, resolution information, format information, sample rate information, bit information, and channel number information of the image data in a frame unit in the shared memory with the image data in a frame unit.

The apparatus may further include: an abstract unit which locates in the native layer, includes a file descriptor that may be exclusively accessible to the image capturing device, determines connection of the image capturing device and manages the access authority of the image capturing device; a library which locates in the native layer and comprises functions for controlling the image capturing device; and an apparatus controller which locates in the native layer, transfers the image data received from the image capturing device to the first controller, calls the functions of the library and thus, controls a function of the image capturing device.

When the image capturing device is connected to the mobile device, the first controller may generate the abstract unit and the apparatus controller in corresponding to the connected image capturing device and when the plurality of image capturing devices is connected to the mobile device, the first controller may separately generate the abstract units and the apparatus controllers in corresponding to each of the connected image capturing devices.

According to another aspect of the present invention, there is provided an image data management method of managing image data transferred to a mobile device from an image capturing device connected to the mobile device, the method including: storing the image data transferred from the image capturing device in the shared memory by a first controller located in a native layer, when state information of the shared memory is at a first state, and changing the state information of the shared memory to a second state, when the image data is completely stored in the shared memory; and reading the image data stored in the shared memory by a second controller located in a java layer when the state information of the shared memory is at the second state, and changing the state information of the shared memory to the first state, when the image data stored in the shared memory is completely read.

### BRIEF DESCRIPTION OF THE DRAWINGS

The above and other features and advantages of the present invention will become more apparent by describing in detail exemplary embodiments thereof with reference to the attached drawings in which: FIG. 1 is a block diagram of an image data management apparatus according to an embodiment of the present invention;

FIG. 2 illustrates operation of the image data management apparatus of FIG. 1 according to an embodiment of the present invention;

FIG. 3 is a flowchart of an image data management method according to an embodiment of the present invention;

FIG. 4 is a flowchart of an image data management method according to another embodiment of the present invention; and

### DETAILED DESCRIPTION OF THE INVENTION

The attached drawings for illustrating exemplary embodiments of the present invention are referred to in order to gain a sufficient understanding of the present invention, the merits thereof, and the objectives accomplished by the implementation of the present invention.

Hereinafter, the present invention will be described in detail by explaining exemplary embodiments of the invention with reference to the attached drawings. Like reference numerals in the drawings denote like elements.

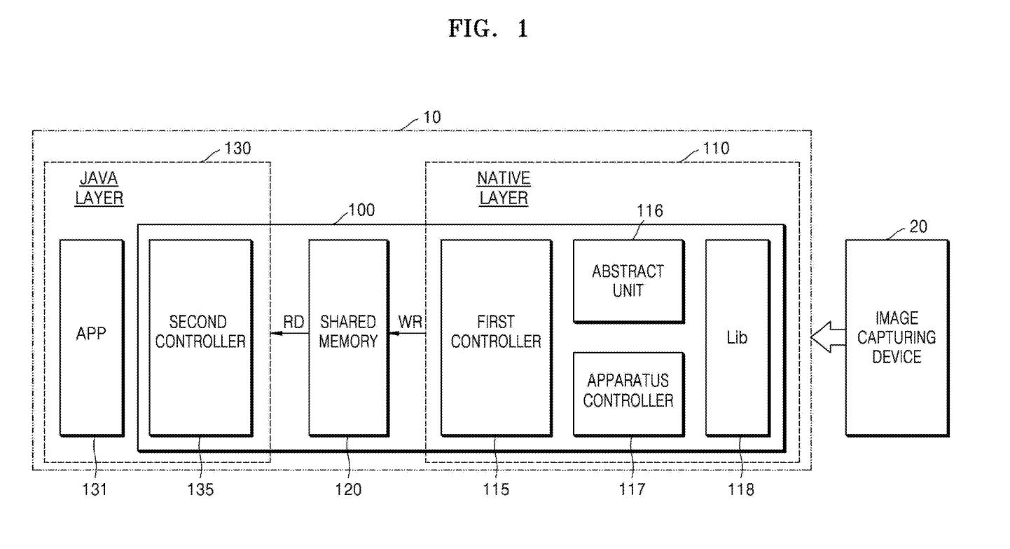

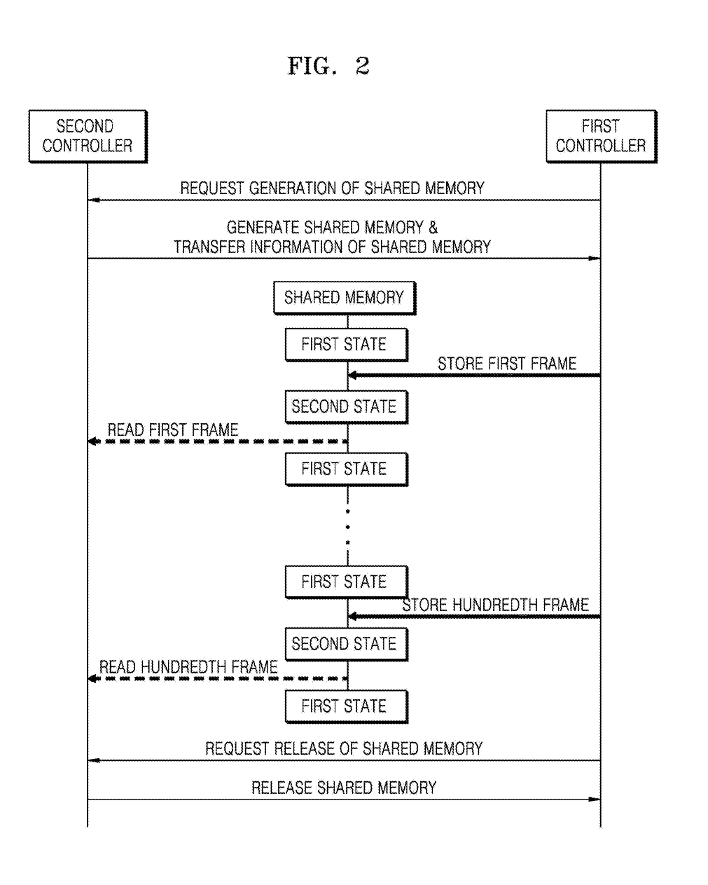

FIG. 1 is a block diagram of an image data management apparatus 100 according to an embodiment of the present invention and FIG. 2 illustrates operation of the image data management apparatus 100.

Referring to FIGS. 1 and 2, the apparatus 100 of managing image data may manage image data transferred from an image capturing device 20. The image capturing device 20 is connected to a mobile device 10 by using, for example, a Universal Serial Bus (USB). Image data captured from the image capturing device 20 is transferred to the mobile device 10 through USB, and the image data transferred to the mobile device 10 is transferred from a native layer 110 to a java layer 130 in the apparatus 100 of managing image data, which will be described in detail below, at high speed. Accordingly, an application 131 may be stably operated. That is, the apparatus 100 of managing image data may be included in the mobile device 10 and an operation system of the mobile device 10 may be Android.

The apparatus 100 of managing image data may include a first controller 115, a second controller 135, a shared memory 120, an abstract unit 116, an apparatus controller 117, and a library 118. The first controller 115 locates in the native layer 110 and may communicate with the java layer 130. Also, as described below, the first controller 115 may store image data in the shared memory 120.

The second controller 135 locates in the java layer 130 and may communicate with the native layer 110. Also, as described below, the second controller 135 may read the image data stored in the shared memory 120 and may transfer the read data to the application 131.

The shared memory 120 may store the image data transferred from the image capturing device 20. Areas to be used as the shared memory 120 may be set to specific areas whether the image capturing device 20 is connected to the mobile device 10. Also, when the image capturing device 20 is connected to the mobile device 10 or when the image data is received in the mobile device 10, areas to be used as the shared memories may be set and then released. For example, when the image capturing device 20 is connected to the mobile device 10 or when the image data is received in the mobile device 10 from the image capturing device 20, information of the image capturing device 20 or information of the image data to be transferred from the image capturing device 20 may be used to set areas to be used as the shared memory 120. Also, when the image capturing device 20 connected to the mobile device 10 is separated from the mobile device 10 or the image data is not received from the image capturing device 20, areas set as the shared memory 120 may be released. This will be described in detail below.

The first controller 115 may store the image data transferred from the image capturing device 20 in the shared memory 120 when state information of the shared memory 120 is a first state. In addition, the first controller 115 may change the state information of the shared memory 120 from the first state to a second state when the image data is completely stored in the shared memory 120. The second controller 135 may read the image data stored in the shared memory 120 when state information of the shared memory 120 is the second state. In addition, the second controller 135 may change the state information of the shared memory 120 from the second state to the first state when the image data stored in the shared memory 120 is completely read. The state information informs of a state whether the image data may be stored in the shared memory 120 or whether the image data stored in the shared memory 120 may be read. When the state information of the shared memory 120 is the first state, it denotes that the image data may be stored in the shared memory 120. When the state information of the shared memory 120 is the second state, it denotes that the image data stored in the shared memory 120 may be read. For example, when a bit that designates the state information in the shared memory 120 is ‘0’ and ‘1’, it may be designated as the first state and the second state, respectively.

The abstract unit 116 locates in the native layer 110 and includes a file descriptor which may be exclusively accessible to the image capturing device 20. Also, the abstract unit 116 may determine connection of the image capturing device 20 and manage the access authority of the image capturing device 20. That is, the abstract unit 116 is an abstract class of the image capturing device 20 and a file descriptor, which may be exclusively accessible to the image capturing device 20, may exist in the abstract class. All control commands about the image capturing device 20 may be internally processed by reading/writing to the file descriptor. When the image capturing device 20 is connected to the mobile device 10, the first controller 115 may generate the abstract unit 116 in corresponding to the connected image capturing device 20. When a plurality of image capturing devices is connected to the mobile device 10, the first controller 115 may separately generate the abstract unit 116 in corresponding to each of the connected image capturing devices.

The library 118 locates in the native layer 110 and may include functions for controlling the image capturing device 20.

The apparatus controller 117 locates in the native layer 110 and transfers the image data received from the image capturing device 20 to the first controller 115. Also, the apparatus controller 117 may call the functions of the library 118 and thus, control a function of the image capturing device 20. That is, when an command input into the application 131 is to control the function of the image capturing device 20, the second controller 135 transfers the command to the first controller 115, the first controller 115 transfers the command to the apparatus controller 117 through the abstract unit 116, and the apparatus controller 117 calls the function that corresponds to the received command from the library 118, thereby controlling the function of the image capturing device 20. For example, a format list (for example, resolution and frame per second (FPS)) provided from the image capturing device 20 is acquired and transferred to the java layer 130. Then, data input by a user may be received through the application 131 and a format may be changed. In addition, when the image capturing device 20 is a camera, extension functions such as video focusing mode conversion, exposure, zoom, pan&tilt, aperture, brightness, chroma, contrast, gamma, and white balance may be realized. The apparatus controller 117 also transfers the image data received from the image capturing device 20 to the first controller 115. When the image capturing device 20 is connected to the mobile device 10, the first controller 115 may generate the apparatus controller 117 in corresponding to the connected image capturing device 20. When a plurality of image capturing devices is connected to the mobile device 10, the first controller 115 may separately generate the apparatus controllers 117 in corresponding to each of the connected image capturing devices.

Hereinafter, operations of elements included in the apparatus 100 of managing image data will be described in more detail with reference to FIGS. 1 and 2.

When it is realized that the image capturing device 20 is connected to the mobile device 10 or when image data is received from the image capturing device 20 connected to the mobile device 10, the first controller 115 may transfer a generation request signal to the second controller 135 for requesting generation of the shared memory 120. Whether the image capturing device 20 is connected to the mobile device 10 may be determined in the first controller 115 or the abstract unit 116. The generation request signal may include information about a frame size of the image data.

When the second controller 135 receives the generation request signal, the second controller 135 may generate the shared memory 120. That is, the second controller 135 may set an area to be used as the shared memory 120 in response to the generation request signal, for example, an address of the area to be used as the shared memory 120. When the generation request signal includes information about a size of the frame, the second controller 135 may use the information to generate the shared memory 120 having a size larger than the frame size. The image data may be stored in the shared memory 120 in a frame unit, however, the present invention is not limited thereto. As described below, the shared memory 120 may be each set in a unit other than a frame unit, if the apparatus 100 of managing image data may be operated, and the image data may be stored in shared memory 120.

While the second controller 135 generates the shared memory 120, the second controller 135 designates state information of the shared memory 120 as the first state and thus may indicate a state that the image data may be stored in the shared memory 120. When the second controller 135 generates the shared memory 120, the second controller 135 may transfer information of the shared memory 120 to the first controller 115. The information of the shared memory 120 may include address information and the state information of the shared memory 120.

As above, a case, when an area of the shared memory 120 is not set, is described. However, when the shared memory 120 is already set, the apparatus 100 of managing image data may skip operation of setting the shared memory 120, which is described above, and may only perform operation of transferring the image data, which will be described below.

FIG. 2 illustrates that image data having 100 frames is transferred from the image capturing device 20 and the image data is stored in the shared memory 120 in a frame unit. Hereinafter, transferring of the image data having 100 frames is described. However, the present invention is not limited thereto. Transferring of image data including different numbers of frames or storing of image data in the shared memory in a different unit may be also operated in a same manner as described below.

Here, new image data is received. Accordingly, the state information of shared memory 120 maintains the first state and thus, the first controller 115 stores a first frame of the image data transferred to the mobile device 10 in the shared memory 120. When the first controller 115 completely stores the first frame in the shared memory 120, the first controller 115 changes the state information of the shared memory 120 from the first state to the second state. Since the state information of the shared memory 120 is changed to the second state, the second controller 135 reads the first frame stored in the shared memory 120. When the second controller 135 completely reads the first frame stored in the shared memory 120, the second controller 135 changes the state information of the shared memory 120 from the second state to the first state.

Since the state information of the shared memory 120 is changed to the first state, the first controller 115 may store a second frame of the image data in the shared memory 120 and changes the state information of the shared memory 120 to the second state after storing is completed. Since the state information of the shared memory 120 is changed to the second state, the second controller 135 reads the second frame stored in the shared memory 120 and changes the state information of the shared memory 120 to the first state after reading is completed.

Since the operations above are repeatedly performed up to 100 frames, 100 frames are all transferred from the first controller 115 to the second controller 135 and the second controller 135 may transfer each read frame to the application 131.

For convenience of description, it is illustrated above that only frames are stored in the shared memory 120. However, the present invention is not limited thereto and related information other than image data in a frame unit may be stored. For example, the first controller 115 may store at least one of timestamp information, size information, resolution information, format information, sample rate information, bit information, and channel number information in the shared memory 120 with the image data in a frame unit and the second controller 135 may read all data stored in the shared memory 120.

When the image capturing device 20 connected to the mobile device 10 is separated from the mobile device 10 or when the image data is not received in the image capturing device 20, the first controller 115 may transfer a completion signal to the second controller 135 for requesting a release of the shared memory 120. Whether the image capturing device 20 is separated from the mobile device 10 may be determined in the first controller 115 or the abstract unit 116. When the second controller 135 receives the completion signal, an area set as the shared memory 120 may be released and the release of the area may be informed to the first controller 115.

As described above, the image data transferred from the image capturing device 20 may be transferred to the application 131 at high-speed. That is, in the present invention, the number of storing and reading data may be reduced by half compared to that of in the conventional art and thus, image data may be transferred at high-speed. In the conventional art, in order to transfer an image from the native layer 110 to the java layer 130, the image data is stored in the memory located in the native layer 110 to be read and the read data is stored in the memory located in the java layer 130 to be read, thereby transferring the image to the application 131. However, in the present invention, the data stored in the shared memory 120 is directly read from the second controller 135 and then may be transferred to the application 131. Accordingly, a high-speed transfer of the image data may be available.

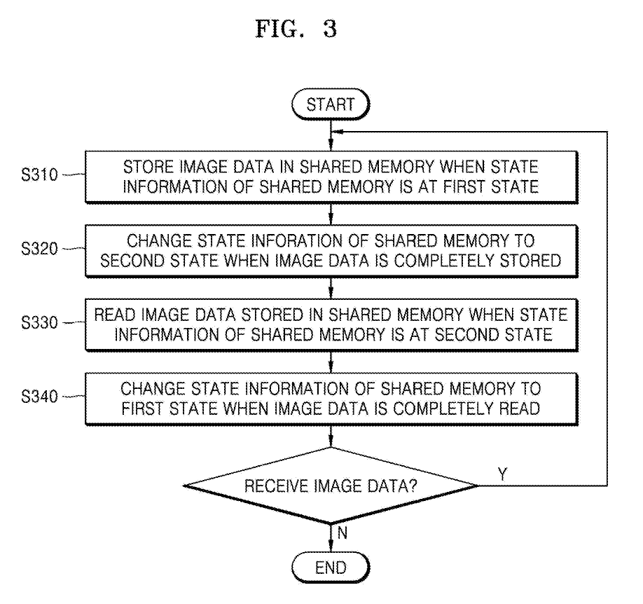

FIG. 3 is a flowchart of an image data management method according to an embodiment of the present invention.

Hereinafter, a method of managing the image data transferred from the image capturing device 20 connected to the mobile device 10 to the mobile device 10 for managing the image data in the mobile device 10 will be described with reference to FIGS. 1 through 3. Descriptions overlapped will be replaced with the descriptions illustrated above with reference to FIGS. 1 and 2.

Firstly, when the state information of the shared memory 120 is the first state, the first controller 115 located in the native layer 110 stores the image data transferred from the image capturing device 20 in the shared memory 120, in operation S310, and changes the state information of the shared memory 120 to the second state, when the image data is completely stored in the shared memory 120, in operation S320. When the state information of the shared memory 120 is changed to the second state, the second controller 135 located in the java layer 130 reads the image data stored in the shared memory 120, in operation S330, and changes the state information of the shared memory 120 to the first state, when the image data stored in the shared memory 120 is completely read, in operation S340.

As the above operations are repeatedly performed while receiving the image data, the image data transferred from the image capturing device 20 may be transferred from the native layer 110 to the java layer 130 at high-speed.

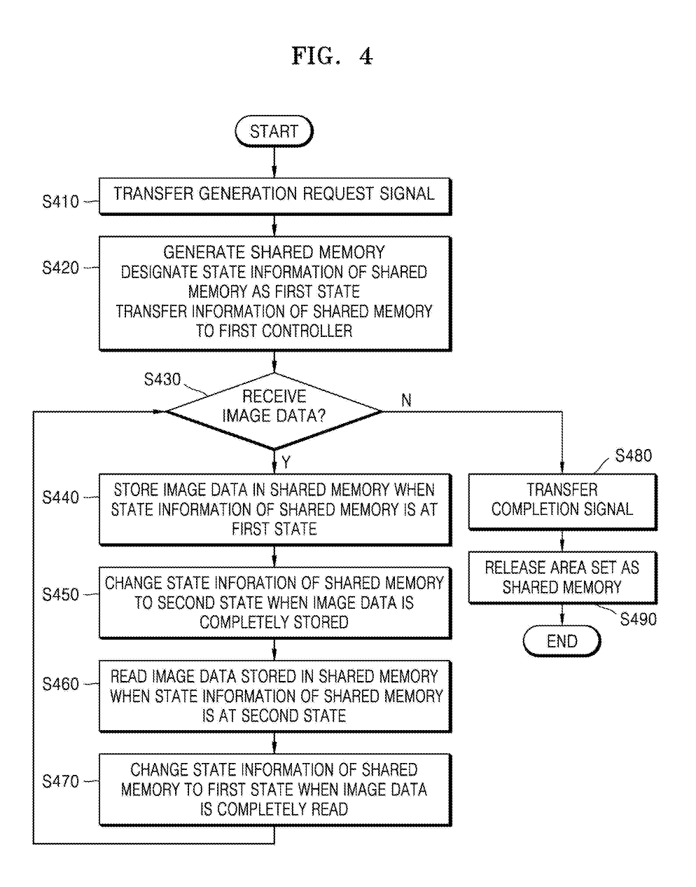

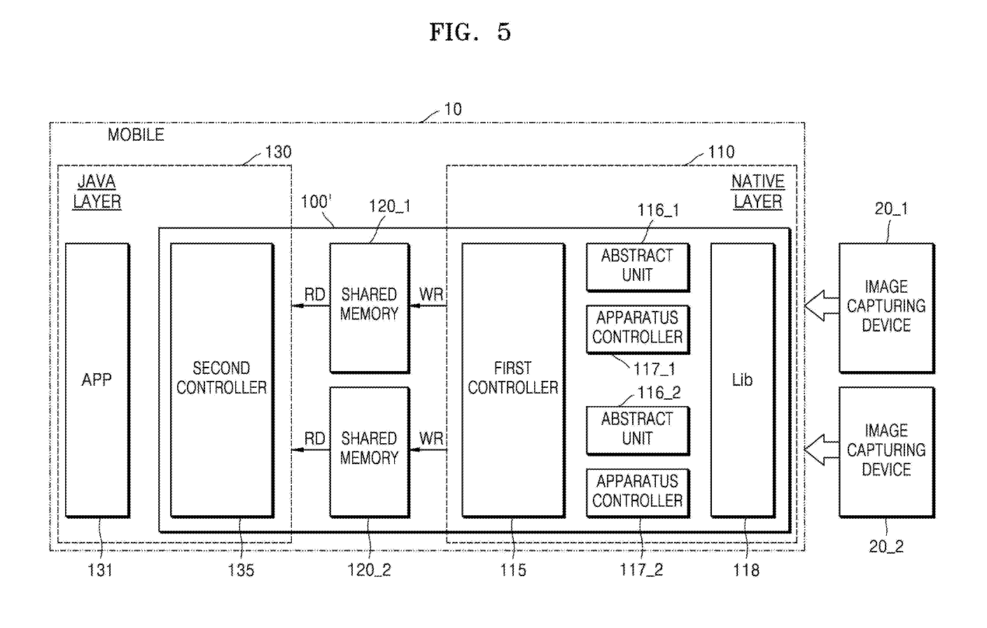

FIG. 4 is a flowchart of an image data management method according to another embodiment of the present invention.

Hereinafter, a method of managing the image data transferred from the image capturing device 20 connected to the mobile device 10 to the mobile device 10 for managing the image data in the mobile device 10 will be described with reference to FIGS. 1 through 4. Descriptions overlapped will be replaced with the descriptions illustrated above with reference to FIGS. 1 through 3.

Firstly, when it is recognized that the image capturing device 20 is connected to the mobile device 10 or when the image data is received from the image capturing device 20 connected to the mobile device 10, the first controller 115 located in the native layer 110 transfers the generation request signal for requesting generation of the shared memory 120 to the second controller 135 located in the java layer 130, in operation S410. When the second controller 135 receives the generation request signal, the second controller 135 sets an area to be used as the shared memory 120, generates the shared memory 120, designates state information of the shared memory 120 as the first state, and transfers the information of the shared memory 120 the first controller 115, in operation S420.

Then, when the image data is transferred from the image capturing device 20 to the mobile device 10, in operation S430, the first controller 115 stores the transferred image data in the shared memory 120, in operation S440. The first controller 115 changes the state information of the shared memory 120 to the second state, when the image data is completely stored in the shared memory 120, in operation S450. When the state information of the shared memory 120 is changed to the second state, the second controller 135 reads the image data stored in the shared memory, in operation S460. When the image data stored in the shared memory 120 is completely read, the state information of the shared memory 120 is changed to the first state, in operation S470. As the above operations are repeatedly performed while receiving the image data, the image data transferred from the image capturing device 20 may be transferred from the native layer 110 to the java layer 130 at high-speed. However, when the image data is completely received and thus, is not transferred to the mobile device 10 anymore or when the image capturing device 20 connected to the mobile device 10 is separated from the mobile device 10, in operation S430, the first controller 115 transfers the completion signal to the second controller 135, in operation S480, and the second controller 135 may release the area set as the shared memory 120, in operation S490, when the second controller 135 receives the completion signal.

As described above, one image capturing device 20 is connected to the mobile device 10, however, the present invention is not limited thereto. When a plurality of image capturing devices 20 is connected to the mobile device 10, the same operations as described above may be also performed. Thus, the received image data may be transferred from the native layer 110 to the java layer 130 at high-speed. FIG. 5 is a block diagram of an image data management apparatus 100′ when a plurality of image capturing devices 20_1 and 20_2 is connected to the mobile device 10.

Referring to FIGS. 1 through 5, when the plurality of image capturing devices 20_1 and 20_2 is connected to the mobile device 10, a shared memory 120_1, an abstract unit 116_1, and an apparatus controller 117_1 each corresponding to the image capturing device 20_1 may be generated, and a shared memory 120_2, an abstract unit 116_2, and an apparatus controller 117_2 each corresponding to the image capturing device 20_2 may be generated. For example, the first controller 115 receives image data transferred from the image capturing device 20_1 through the apparatus controller 117_1 and the image data is stored in the shared memory 120_1. The second controller 135 may recognize that the image data read from the shared memory 120_2 is captured in the image capturing device 20_1. That is, when the plurality of image capturing devices 20_1 and 20_2 is connected, the shared memories, the abstract unit, and the apparatus controller are generated in each of the image capturing device. Functions of each element are the same as that of described with reference to FIGS. 1 through 4 and thus descriptions of each element will be replaced with that of described with reference to FIGS. 1 through 4.

In setting of a plurality of shared memories when the plurality of image capturing devices is connected to the mobile device 10, the first controller 115 may separately generate the generation request signal for each of the connected image capturing devices 20_1 and 20_2 and transfer the generation request signals to the second controller 135. Also, the second controller 135 may set areas to be used as the shared memories 120_1 and 120_2 for each received generation request signal. That is, the second controller 135 generates the shared memories 120_1 and 120_2 for each of the plurality of image capturing devices 20_1 and 20_2 by using the received generation request signals, designates state information of the generated shared memories 120_1 and 120_2 as the first state, and transfers information of each of the shared memories 120_1 and 120_2 to the first controller 115. In addition, when the plurality of image capturing devices 20_1 and 20_2 is connected to the mobile device 10, the first controller 115 may generate the abstract units 116_1 and 116_2 and the apparatus controllers 117_1 and 117_2 for each corresponding image capturing devices 20_1 and 20_2.

In the apparatus and the method of managing image data according to the present invention, image data transferred from an image capturing device connected to a mobile device to the mobile device may be transferred from a native layer to a java layer at high-speed and thus an image may be stably provided to an application. That is, in the conventional art, a delay may occur while transferring data from the native layer to the java layer so that only 3 frames per second is transferred. However, according to the present invention, more than 30 frames per second may be transferred so that a transfer of not only images of HD resolution (1280×720, MJPEG compression) but also images of full HD resolution (1920×1080, MJPEG compression) may be available. Therefore, according to the present invention, a high-speed transfer of images is available so that high-definition image data or image data transferred from a plurality of image capturing devices may be used to stably run applications. Also, in the present invention, images captured by the image capturing devices may be stably played or broadcasted in real-time through the mobile device without a disconnection.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image data management apparatus for managing image data transferred to a mobile device from an image capturing device connected to the mobile device, the apparatus comprising:
a first controller located in a native layer for communicating with a java layer;
a second controller located in a java layer for communicating with the native layer; and
a shared memory in which the image data transferred from the image capturing device is stored,
wherein the first controller stores the image data transferred from the image capturing device in the shared memory when state information of the shared memory is at a first state, and changes the state information of the shared memory to a second state when the image data is completely stored in the shared memory, and
wherein the second controller reads the image data stored in the shared memory when the state information of the shared memory is at the second state, and changes the state information of the shared memory to the first state when the image data stored in the shared memory is completely read.

2. The apparatus of claim 1, wherein when it is recognized that the image capturing device is connected to the mobile device or when the image data is received from the image capturing device connected to the mobile device, the first controller transfers a generation request signal to the second controller for requesting generation of the shared memory and wherein when the second controller receives the generation request signal, the second controller generates the shared memory, designates the state information of the shared memory as the first state, and transfers the information of the shared memory to the first controller.

3. The apparatus of claim 2, wherein when a plurality of image capturing devices is connected to the mobile device, the first controller transfers the generation request signals to the second controller for each of the connected image capturing devices and the second controller generates the shared memories for each of the plurality of image capturing devices by using the received generation request signals.

4. The apparatus of claim 2, wherein the generation request signal comprises information about a frame size of the image data and the second controller generates the shared memory having a size larger than the frame size by using the information about a frame size of the image data and transfers information of the shared memory comprising address information and the state information of the generated shared memory.

5. The apparatus of claim 1, wherein the first controller transfers a completion signal when the image capturing device connected to the mobile device is separated from the mobile device or the image data is not received from the image capturing device, and wherein the second controller releases an area set as the shared memory when the completion signal is received.

6. The apparatus of claim 1, wherein the first controller stores the image data in the shared memory in a frame unit and stores at least one of timestamp information, size information, resolution information, format information, sample rate information, bit information, and channel number information of the image data in a frame unit in the shared memory with the image data in a frame unit.

7. The apparatus of claim 1, further comprising:
an abstract unit which locates in the native layer, comprises a file descriptor that may be exclusively accessible to the image capturing device, determines connection of the image capturing device and manages the access authority of the image capturing device;
a library which locates in the native layer and comprises functions for controlling the image capturing device; and
an apparatus controller which locates in the native layer, transfers the image data received from the image capturing device to the first controller, calls the functions of the library and thus, controls a function of the image capturing device.

8. The apparatus of claim 7, wherein when the image capturing device is connected to the mobile device, the first controller generates the abstract unit and the apparatus controller in corresponding to the connected image capturing device and when the plurality of image capturing devices is connected to the mobile device, the first controller separately generates the abstract units and the apparatus controllers in corresponding to each of the connected image capturing devices.

9. An image data management method of managing image data transferred to a mobile device from an image capturing device connected to the mobile device, the method comprising:
storing the image data transferred from the image capturing device in the shared memory by a first controller located in a native layer, when state information of the shared memory is at a first state, and changing the state information of the shared memory to a second state, when the image data is completely stored in the shared memory; and
reading the image data stored in the shared memory by a second controller located in a java layer when the state information of the shared memory is at the second state, and changing the state information of the shared memory to the first state, when the image data stored in the shared memory is completely read.

10. The method of claim 9, further comprising:
when it is recognized that the image capturing device is connected to the mobile device or when the image data is received from the image capturing device connected to the mobile device, transferring a generation request signal from the first controller to the second controller for requesting generation of the shared memory; and
when the second controller receives the generation request signal, generating the shared memory, designating the state information of the shared memory as the first state, and transferring the information of the shared memory to the first controller.

11. The method of claim 10, wherein the transferring of the generation request signal further comprises, when a plurality of image capturing devices is connected to the mobile device, transferring the generation request signals from the first controller to the second controller for each of the connected image capturing devices and wherein the transferring of the information of the shared memory further comprises, when a plurality of generation request signals is received in the second controller, generating the shared memories for the plurality of image capturing devices by using the received generation request signals, designating the state information of the shared memories as the first state, and transferring the information of the shared memories to the first controller.

12. The method of claim 9, further comprising:
transferring a completion signal from the first controller to the second controller when the image capturing device connected to the mobile device is separated from the mobile device or the image data is not received from the image capturing device; and
in the second controller, when the completion signal is received, releasing an area set as the shared memory.

13. The method of claim 9, further comprising:
when the image capturing device is connected, generating an abstract unit in the native layer for managing the access authority of the image capturing device after determining connection or separation of the image capturing device; and
when the image capturing device is connected, generating an apparatus controller in the native layer for transferring the image data received from the image capturing device to the first controller, calling functions of a library and controlling a function of the image capturing device.

14. The method of claim 13, further comprising:
when a plurality of image capturing devices is connected to the mobile device, generating the abstract units and the apparatus controllers for each corresponding image capturing devices.
